(19) United States
(12) Patent Application Publication
(10) Pub. No.: US 2010/0326293 A1
(43) Pub. Date: Dec. 30, 2010

(54) METHOD AND APPARATUS FOR REMOVING LIQUIDS FROM COOKED FOODS

(75) Inventor: Kevin M. Derubeis, Aurora, OH (US)

Correspondence Address: SAND & SEBOLT, AEGIS TOWER, SUITE 1100, 4940 MUNSON STREET, NW, CANTON, OH, 44718-3615, US

(73) Assignee: A. G. P. C., INC., Massillon, OH (US)

(21) Appl. No.: 12/823,557

(22) Filed: Jun. 25, 2010

Related U.S. Application Data
(60) Provisional application No. 61/269,666, filed on Jun. 26, 2009.

(51) Int. Cl. B30B 9/06

(52) U.S. Cl. 100/37; 100/110

(57) ABSTRACT

Methods, apparatus and other embodiments associated with removing liquids from food are presented. A liquid removing device to remove liquids and fat from food includes a top plate and a bottom plate. The bottom plate has an upper surface formed with rows and columns of a first shape projecting outward from the upper surface. The top plate has a bottom surface movably attached to the bottom formed with rows and columns of a second shape projecting outward from the lower surface. Liquid and fat is removed from food placed between the bottom plate and the top plate when the upper surface of the bottom plate is pressed toward the bottom surface of the upper plate.

### CROSS-REFERENCE TO RELATED APPLICATIONS

This is a standard utility application claiming priority from U.S. Provisional Patent Application Ser. No. 61/269,666, filed Jun. 26, 2009, the entire specification of which is incorporated herein by reference.

### BACKGROUND OF THE INVENTION

1. Technical Field

The present invention relates generally to apparatus and methods for processing cooked foods. More particularly, the apparatus and methods relate to removing liquids from cooked foods. Specifically, the methods and systems of the present invention involve removing, liquids, fat and oils from cooked foods.

2. Background Information

In wake of the public awareness over the dangers of cholesterol and high fat diets, there has been a trend to lowering the amount of fat in one's diet. However, despite this trend, people of all cultures and all ethnic groups enjoy and will continue to enjoy numerous varieties of pan-fried foods. Often, these foods are prepared by frying meat in a pan. The meat is often fried in its own grease while it is cooked. Some pans contain grooves or tapered surface so that as meat is cooked the grease is extracted so that it flows away from the meat. This may help remove some of the fat as the meat is cooked; however, the meat can still have significant amounts of unwanted fat and oils within the cooked meat. Additionally, even foods cooked over a flame or on a barbeque can still retain significant amounts of fat and other unwanted liquids and oils at the end of the cooking process. A better way of preparing cooked foods is needed.

### BRIEF SUMMARY OF THE INVENTION

The preferred embodiment includes an apparatus for removing liquids and fats from cooked foods. The apparatus includes a 3-dimensional shape, a bottom plate and a top plate. The top plate and the bottom plate are formed with generally rigid food grade polymer. The bottom plate has a bottom surface and an upwardly facing top surface formed with a first array of the 3-dimensional shapes extending upward from the top surface. The top plate has a top surface and a downwardly facing bottom surface formed with a second array of the 3-dimensional shapes extending downward from the bottom surface. A connection device connects the bottom plate to the top plate to allow the top plate to be moved to an open position to allow cooked food to be placed on the top surface of the bottom plate. The connection device is adapted to move the top plate to an engaged position where the top plate is in contact with food on the bottom plate so that the food is sandwiched between the top plate and the bottom plate. In the engaged position, the top plate and bottom plate are adapted to be squeezed together to remove liquids and fats from within the food.

In one configuration of the preferred embodiment, the first array of 3-dimensional shapes forms a 2-dimensional sheet with at least two rows of the 3-dimensional shape and a least two columns of the 3-dimensional shape. Similarly, the second array of 3-dimensional shapes forms a 2-dimensional sheet with at least two rows of the 3-dimensional shape and a least two columns of the 3-dimensional shape.

In another configuration of the preferred embodiment, the 3-dimensional shape is generally a pyramid shape. The pyramid shape extends upward from the top surface of the bottom plate about ⅜ an inch. The pyramid shape has a generally square base with a rounded point extending outward from the base and the pyramid can have four sides. A side of the base is between 0.25 inches and one inch in length.

In one configuration of the preferred embodiment, the first array of 3-dimensional shapes is formed with between 13 to 23 columns of the 3-dimensional shape and between 5 and 15 rows of the 3-dimensional shape. Similarly, the second array of 3-dimensional shapes is formed with between 13 to 23 columns of the 3-dimensional shape and between 5 and 15 rows of the 3-dimensional shape.

### BRIEF DESCRIPTION OF THE SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a perspective view of the preferred embodiment of an apparatus for removing liquid and fat from cooked foods in a closed position.

FIG. 2 illustrates a perspective view of the preferred embodiment of an apparatus for removing liquid and fat from cooked foods in an open position.

FIG. 3 illustrates a detailed view of the pyramid shapes of the preferred embodiment of an apparatus for removing liquid and fat from cooked foods.

FIG. 4 illustrates a top view of the preferred embodiment of an apparatus for removing liquid and fat from cooked foods configured with strap hinges.

FIG. 4A illustrates a top view of the preferred embodiment of an apparatus for removing liquid and fat from cooked foods configured with a hinge with a biasing device.

FIG. 5 illustrates a partial side view of the preferred embodiment of an apparatus for removing liquid and fat from cooked foods.

FIG. 6 illustrates a side view of the preferred embodiment of an apparatus for removing liquid and fat from cooked foods with food and absorbent sheets.

FIG. 7 illustrates a method of removing liquid and fat from cooked foods.

Similar numbers refer to similar parts throughout the drawings.

### DETAILED DESCRIPTION OF THE INVENTION

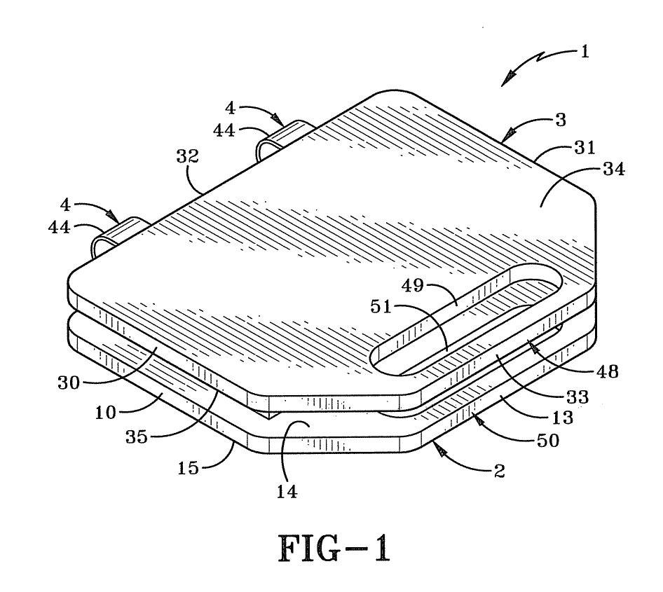

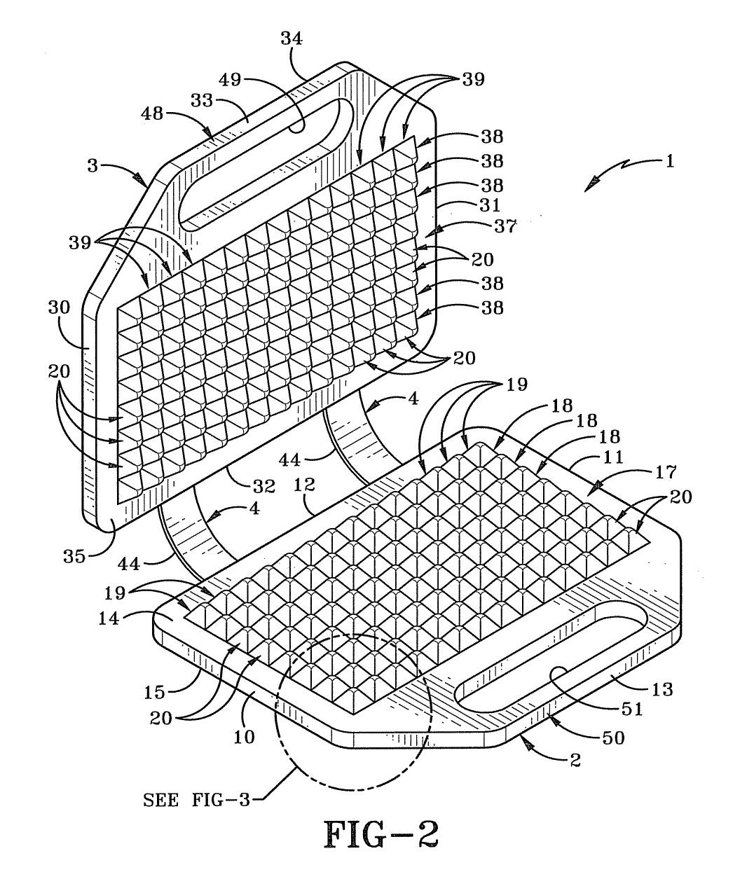

FIGS. 1 and 2 illustrate a first embodiment of an apparatus 1 used to remove liquids and fat from cooked foods. The apparatus includes a bottom plate 2, a top plate 3 and a connection device 4. As discussed later, food is placed between the bottom and top plates 2, 3 and the plates 2, 3 are pressed together to squeeze liquids such as fat out of the food. The bottom and top plates 2, 3 are made out of food grade polymer plastic and are generally rigid. Those of ordinary skill in the art will realize that the components of the preferred embodiment can be made out of other suitable materials.

The bottom plate 2 has a left side 10, a right side 11, a back side 12 a front side 13, a top surface 14 and a bottom surface 15. The top surface 14 faces upward and is formed with an array of 3-dimensional shapes 17 extending upward from the top surface 14. In the preferred embodiment, the array of 3-dimensional shapes 17 is formed as a 2-dimensional sheet with at least two rows 18 of a 3-dimensional shape and a least two columns 19 of the 3-dimensional shape.

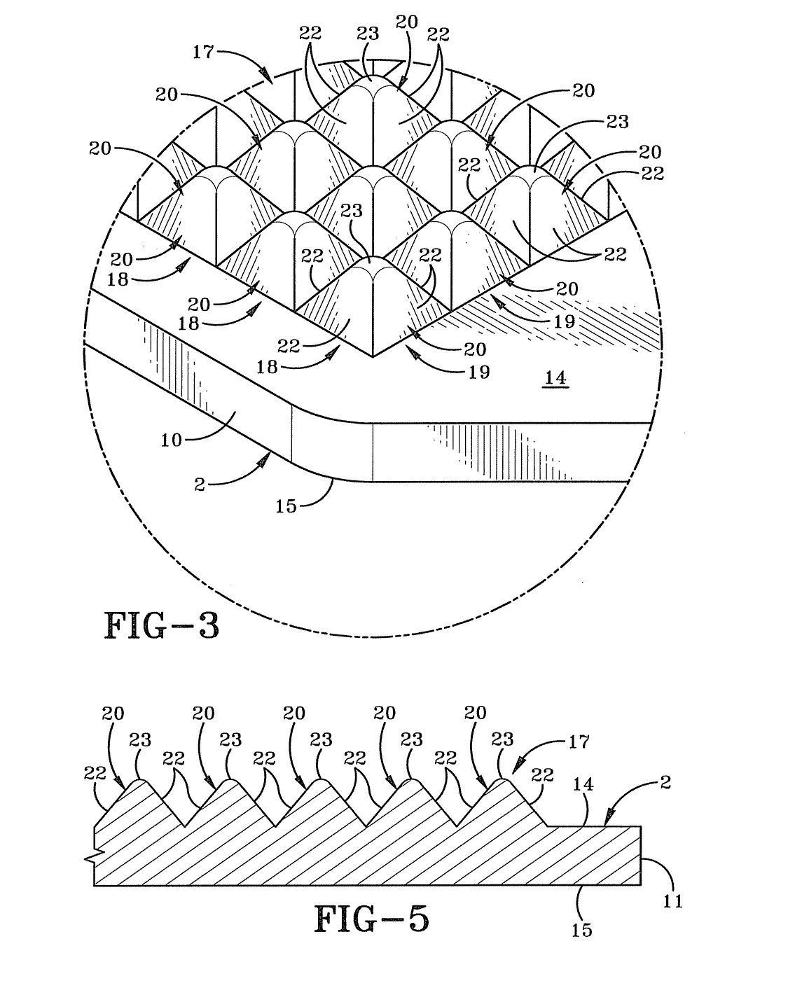

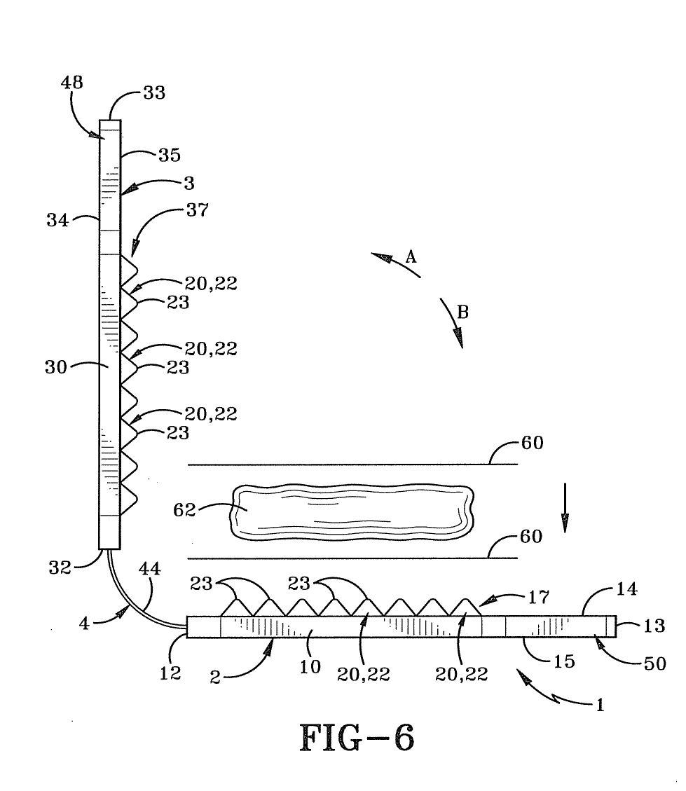

In the preferred embodiment, the 3-dimensional shape is generally a pyramid shape 20 as is best seen in FIGS. 3 and 5. The pyramid shape 20 has a generally square base, four sides 22 that form a rounded point 23 extending outward and upward from the bottom plate 2. The pyramid shape 20 extends upward from the top surface 14 of the bottom plate 2 about ⅜ an inch. A side of the base of one pyramid shape 20 is generally between 0.25 inches and one inch in length. A side of the base is about ½ of an inch in length.

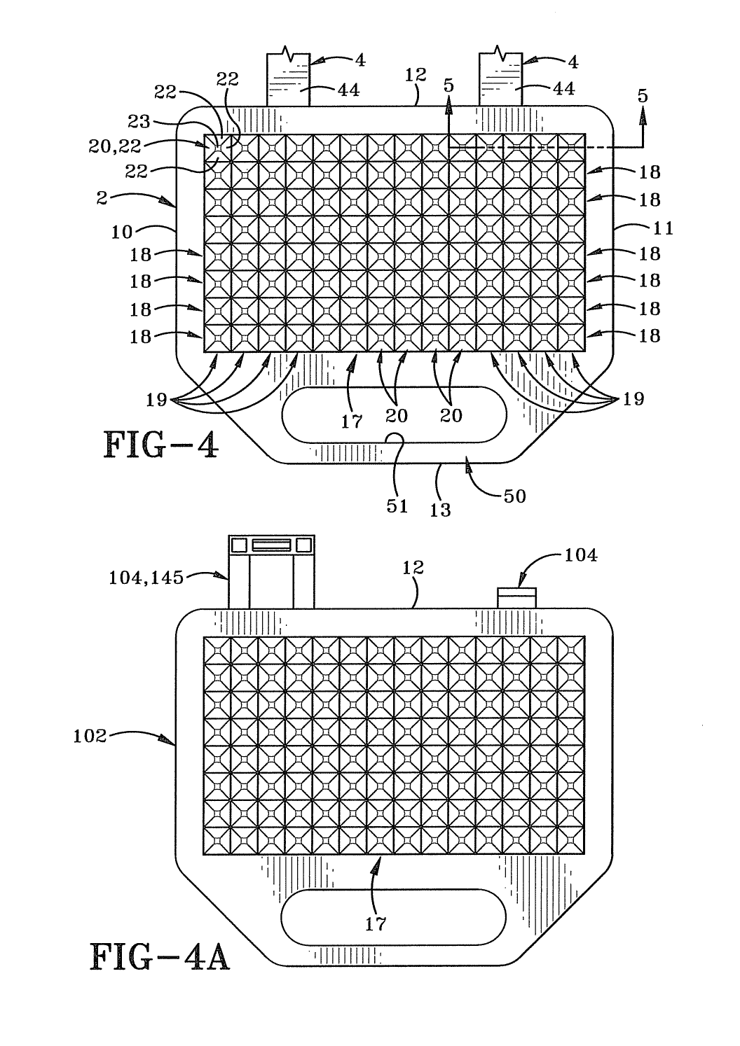

The top plate 3 is formed similar to the bottom plate 2 and may be a partial mirror image of the bottom plate 2. The top plate 3 has a left side 30, a right side 31, a back side 32 a front side 33, a top surface 34 and a bottom surface 35. The bottom surface 35 faces downward when the bottom and top plates 2, 3, are in the engaged position as described below. As best seen in FIG. 4, the bottom surface 35 is formed with an array of 3-dimensional shapes 37 extending downward from the bottom surface 35. The 3-dimensional shape that is arrayed may be the same as the pyramid shape 20 of the bottom plate 2 or it may be a different shape. Similar to the bottom plate 2, the array of 3-dimensional shapes 37 is formed as a 2-dimensional sheet with at least two rows 38 of the 3-dimensional shape and a least two columns 39 of the 3-dimensional shape. Also, similar to the bottom plate 2, the array of 3-dimensional shapes 37 of the top plate 3 is formed with between 13 to 23 columns of the 3-dimensional shape and between 5 and 15 rows of the 3-dimensional shape.

The connection device 4 may be comprised of a pair of hinge devices 44. As shown in FIG. 4A one of the connection devices 104 may include a bias device 145 that can apply a bias to push the top plate toward the bottom plate 102 when the apparatus 1 is in the engaged position. Those of ordinary skill in the art will appreciate that other types of hinge devices 44 and bias devices 145 can be used.

In one configuration of the preferred embodiment, a handle shape 48 with a top handle opening 49 may be formed in the top plate 3 and a complementary handle shape 50 with a bottom handle opening 51 can be formed in the bottom plate 2. These handles 48, 50 can be used to carry/transport the apparatus 1 or used to apply pressure when the top and bottom plates 2, 3 are in the engaged position.

Having described the structure of the apparatus 1 for removing liquids and fat from food, the used of the apparatus 1 is now discussed. In general, food such as meat is first cooked and then the top plate 3 is moved upward from the bottom plate 2 so that the food can be placed on the bottom plate 2. Next, the top plate 3 is moved downward so that it is in contact with the food on the bottom plate 2 so that the food is sandwiched between the two plates in an engaged position. In one configuration of the preferred embodiment, the bias device 45 will apply at least some bias to squeeze the food while it is in the engaged position. This will squeeze liquids and fats from the food so that the liquids and fat flows between the array of pyramid shapes 20 and out of apparatus 1.

As shown in FIG. 6 liquid and fat absorbing sheets 60 can also be used. For example, an absorbent sheet 60 be placed on the top surface 14 of the bottom plate 2 and then the food 62 can be placed on this sheet. Another sheet 60 can be placed over the food and the second plate 3 can be lowered onto this sheet. Now, when pressure is applied to squeeze the food 62, the liquids and fats will now be absorbed by the two sheets 60 so that apparatus 1 stays cleaner than without using the absorbent sheets 60. The liquid absorbent material can be comprised of an absorbent side and a non-absorbent side. In this case, the non-absorbent side is placed toward the bottom plate 2 and the food 62 is placed on the absorbent side of the liquid absorbent material.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

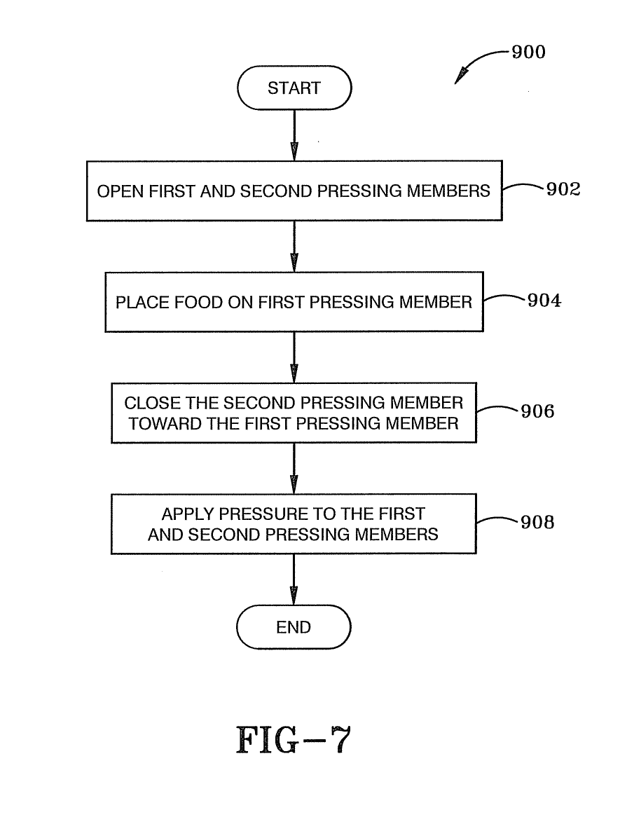

FIG. 7 illustrates a method 900 of removing liquids from food. The method 900 opens a first pressing member and a second pressing member to an open position, at 902. When the pressing members are in the open position, food is placed on the first pressing member, at 904. The food may be, for example, cooked meat. A liquid absorbent material can be placed on the first pressing member before placing food on the first pressing member. The second pressing member is moved toward the first pressing member, at 906, so that the food is sandwiched between the first pressing member and the second pressing member in an engaged position. An array of 3-dimensional objects formed in the first pressing member is protruding toward the food and an array of 3-dimensional objects formed in the second pressing member is protruding toward the food in the engaged position. These 3-dimensional objects may be pyramids as discussed earlier. Pressure is added to the first pressing member and the second pressing member, at 908, to move the array of 3-dimention objects on the second pressing member toward the array of 3-densional objects formed in the first pressing member so that liquid and fat is removed from the food.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. An apparatus for removing liquids and fats from cooked foods comprising:
a 3-dimensional shape;
a bottom plate with bottom surface and an upwardly facing top surface formed with a first array of the 3-dimensional shapes extending upward from the top surface;
a top plate with a top surface and a downwardly facing bottom surface formed with a second array of the 3-dimensional shapes extending downward from the bottom surface;
a connection device connecting the bottom plate to the top plate to allow the top plate to be moved to an open position to allow food to be placed on the top surface of the bottom plate, wherein the connection device is adapted to move the top plate to an engaged position where the top plate is in contact with food on the bottom plate so that the food is sandwiched between the top plate and the bottom plate, wherein in the engaged position the top plate and bottom plate are adapted to be squeezed together to remove liquids and fats from within the food.

2. The apparatus of claim 1 wherein the first array of 3-dimensional shapes forms a 2-dimensional sheet with at least two rows of the 3-dimensional shape and a least two columns of the 3-dimensional shape, and wherein the second array of 3-dimensional shape and at least two columns of the 3-dimensional shape.

3. The apparatus of claim 1 wherein the 3-dimensional shape is generally a pyramid shape.

4. The apparatus of claim 3 wherein the 3 pyramid shape extends upward from the top surface of the bottom plate about ⅜ inch.

5. The apparatus of claim 3 wherein the pyramid shape has a generally square base with a rounded point extending outward from the base.

6. The apparatus of claim 3 wherein the pyramid has four sides.

7. The apparatus of claim 3 wherein the pyramid shape has a generally square base, and where a side of the base is between 0.25 inches and one inch in length.

8. The apparatus of claim 3 wherein the pyramid shape has a generally square base, and where a side of the base is about ½ of an inch in length.

9. The apparatus of claim 1 wherein the first array of 3-dimensional shapes is formed with between 13 to 23 columns of the 3-dimensional shape and between 5 and 15 rows of the 3-dimensional shape, and wherein the second array of 3-dimensional shapes is formed with between 13 to 23 columns of the 3-dimensional shape and between 5 and 15 rows of the 3-dimensional shape.

10. The apparatus of claim 1 wherein the top plate and the bottom plate are formed with generally rigid food grade polymer.

11. The apparatus of claim 1 wherein the connection device further comprises:
a pivot axis adapted to rotate the top plate from the open position toward the food on the bottom plate.

12. The apparatus of claim 1 further comprising:
fat absorbing sheets for soaking up fatty liquid, wherein the fat absorbing sheets are configured to be placed between the bottom plate and the food as well as between the food and the top plate.

13. The apparatus of claim 1 wherein a handle shape is formed in the top plate and a similar handle shape is formed in the bottom plate.

14. The apparatus of claim 1 wherein the connection device further comprises:
a bias device to bias the top plate toward the bottom plate.

15. The apparatus of claim 1 wherein the liquids and fats flow between the first array of 3-dimensional shapes and the second array of 3-dimensional shapes toward an outside perimeter of the bottom plate when the top plate and bottom plate are squeezed in the engaged position.

16. A liquid removing device to remove liquids and fat from food comprising:
a bottom plate with an upper surface formed with rows and columns of a first shape projecting outward from the upper surface;
a top plate with a bottom surface movably attached to the bottom plate formed with rows and columns of a second shape projecting outward from the lower surface, wherein liquid and fat is removed from food placed between the bottom plate and the top plate when the upper surface of the bottom plate is pressed toward the bottom surface of the upper plate.

17. The liquid removing device of claim 16, wherein the first shape and the second shape are pyramid shapes.

18. A method removing liquid from food comprising:
opening a first pressing members and a second pressing member to an open position;
placing food on the first pressing member;
closing the second pressing member toward the first pressing member so that the food is sandwiched between the first pressing member and the second pressing member, wherein an array of 3-dimensional objects formed in the first pressing member is protruding toward the food and an array of 3-dimensional objects formed in the second pressing member is protruding toward the food; and
applying pressure to the first pressing member and the second pressing member and the second pressing member to move the array of 3-dimention objects on the second pressing member toward the array of 3-densional objects formed in the first pressing member so that liquid is removed from the food.

19. The method of claim 18 further comprising:
placing a liquid absorbent material on the first pressing member before placing food on the first pressing member.

20. The method of claim 19 wherein the liquid absorbent material is comprised of an absorbent side and a non-absorbent side and the further comprising:
placing the non-absorbent side of the liquid absorbent material toward the first pressing member and the food is placed on the absorbent side of the liquid absorbent material.
